(19) United States
(12) Patent Application Publication
(10) Pub. No.: US 2026/0120071 A1
(43) Pub. Date: Apr. 30, 2026

(54) DRAW LOTTERY TICKET SELLING SYSTEMS CONFIGURED TO EMPLOY DISTRIBUTED PRINTING OF DRAW LOTTERY TICKETS

(71) Applicant: Brightstar Global Solutions Corporation, Providence, RI (US)

(72) Inventors: Paul Schneider, Jerome, ID (US); Sridhar Jawaharlal, Ashburn, VA (US); Corey Edwards, Johnston, RI (US); Jonathan Perry, Cranston, RI (US); David Antolino Rivas, Barcelona (ES); Ratheesh Nair, Dieppe (CA)

(21) Appl. No.: 18/930,131

(22) Filed: Oct. 29, 2024

(51) Int. Cl. G06Q 20/30

(52) U.S. Cl. CPC G06Q 20/30

(57) ABSTRACT

A draw lottery ticket selling system and methods of operating the system that enable the purchase of draw lottery tickets by players, and the remote printing of the draw lottery tickets using different devices.

### BACKGROUND

The present disclosure relates to draw lottery ticket selling systems configured to employ a distributed printing of draw lottery tickets.

For a draw lottery ticket for a draw lottery game, a player may select the player numbers or may have a component of an electronic lottery system randomly select the player numbers (which is often referred to as a quick pick). Draw lottery tickets may be purchased in a variety of different manners using a variety of different systems such as systems that include lottery terminals. Various different jurisdictions (such as states) have different rules regarding how such draw lottery tickets can be purchased.

### BRIEF SUMMARY

In various embodiments, the present disclosure relates a draw lottery ticket selling system including a courier server configured to enable a purchase, via a player electronic device, of a draw lottery ticket provided by a central lottery server. The courier server includes a processor and a memory device that stores a plurality of instructions, which when executed by the processor cause the processor to: receive a request for the draw lottery ticket from the player electronic device; send a request for a purchase of the draw lottery ticket to the central lottery server; receive a purchase response that confirms the purchase of the draw lottery ticket from the central lottery server; assign a lottery ticket printer from a pool of assignable lottery ticket printers to print the draw lottery ticket; and send a purchase confirmation to the player electronic device, the purchase confirmation including a confirmation of the purchase of the draw lottery ticket.

In various other embodiments, the present disclosure relates a draw lottery ticket selling system including an application programming interface (API) server configured to enable a purchase, via a player electronic device, of a draw lottery ticket provided by a central lottery server. The API server includes a processor and a memory device that stores a plurality of instructions, which when executed by the processor cause the processor to: receive a request for the draw lottery ticket from the player electronic device; send a request for a purchase of the draw lottery ticket to the central lottery server; receive a response that confirms the purchase of the draw lottery ticket from the central lottery server; send a purchase confirmation to the player electronic device, the purchase confirmation including a confirmation of the purchase of the draw lottery ticket; and cause the draw lottery ticket to be printed after a winning ticket printing condition has been met.

In various other embodiments, the present disclosure relates a draw lottery ticket selling system including a draw lottery ticket server configured to enable a purchase, via a player electronic device, of a draw lottery ticket provided by a central lottery server. The draw lottery ticket server includes a processor and a memory device that stores a plurality of instructions, which when executed by the processor cause the processor to: receive a request for the draw lottery ticket from the player electronic device; send a request for a purchase of the draw lottery ticket to the central lottery server; receive a response that confirms the purchase of the draw lottery ticket from the central lottery server; and send a purchase confirmation to the player electronic device without printing the draw lottery ticket, the purchase confirmation including a confirmation of the purchase of the draw lottery ticket.

Additional features are described in, and will be apparent from, the following Detailed Description and the figures.

### BRIEF DESCRIPTION OF THE SEVERAL VIEWS OF THE DRAWINGS

FIG. 1 is a diagrammatic view of a first known draw lottery ticket selling system including a lottery terminal, a lottery ticket printer, and a central lottery server.

FIG. 2 is a diagrammatic view of a second known draw lottery ticket selling system including a vendor point of sale device, a lottery ticket printer, a courier server, and a central lottery server.

FIG. 3 is a diagrammatic view of a draw lottery ticket selling system operable with a player electronic device and including a courier server, a distributed pool of lottery ticket printers, and a central lottery server in accordance with one example embodiment of the present disclosure.

FIG. 4 is a flow diagram showing one example method of operation of the draw lottery ticket selling system of FIG. 3 in accordance with one example embodiment of the present disclosure.

### DETAILED DESCRIPTION

In various embodiments, the present disclosure relates to a draw lottery ticket selling system and methods of operating the draw lottery ticket selling system, wherein the draw lottery ticket selling system includes a courier server, a distributed pool of (one or more) lottery ticket printers, and a central lottery server. The draw lottery ticket selling system enables the purchase of draw lottery tickets by players and the printing of such draw lottery tickets from an assigned lottery ticket printer of a distributed pool of (one or more) lottery ticket printers. The assigned lottery ticket printer can be located remotely from where a player purchased the draw lottery ticket. In various embodiments, the printing of the draw lottery tickets can be immediate or at a subsequent point in time.

In various embodiments, the present disclosure provides a draw lottery ticket selling system including a courier server. The courier server enables a separation in location and/or timing between purchasing a draw lottery ticket and the printing of that draw lottery ticket.

In various embodiments, the courier server enables the purchase of a draw lottery ticket and printing of that draw lottery ticket using different devices. In various embodiments, the different devices are at different locations.

In various embodiments, the courier server enables a user to employ their personal electronic device (such as a smartphone or tablet) to purchase a draw lottery ticket and employ a lottery ticket printer associated with a determined establishment such as retail establishment (such as a grocery store or convenience store) for printing of that draw lottery ticket.

In various embodiments, the courier server enables the purchase of the draw lottery ticket at a first time and the printing of the draw lottery ticket at a subsequent second time (which is not immediately after the purchase event).

In various embodiments, the draw lottery ticket selling system enables a player to purchase the draw lottery ticket at a convenient time, such as before leaving the player's home or arriving at a retail location at which the draw lottery ticket will be printed.

In various embodiments, the draw lottery ticket selling system enables a player to purchase the draw lottery ticket, but postpone printing of the draw lottery ticket until a later convenient time.

In various embodiments, the draw lottery ticket selling system avoids the initial printing the draw lottery ticket right after the purchase. In various such embodiments, if the draw lottery ticket is not a winning draw lottery ticket, that draw lottery ticket is never printed. In various such embodiments, the draw lottery ticket selling system enables the subsequent printing of the draw lottery ticket if the draw lottery ticket is a winning lottery ticket or is a winning lottery ticket wherein the amount won is above a predetermined threshold.

Draw lottery tickets for draw lottery games are employed as example lottery tickets herein; however, it should be appreciated that the present disclosure is not meant to be limited by such examples.

A draw lottery ticket can include: (1) a single set of player numbers for a single play of a draw lottery game; (2) multiple sets of player numbers for a single play of a draw lottery game; (3) a single set of player numbers for each of multiple plays of a draw lottery game; or (4) multiple sets of player numbers for each of multiple plays of a draw lottery game. For simplicity, the present disclosure uses a draw lottery ticket with a single set of player numbers for a single play of a draw lottery game as an example, but it should be appreciated that the present disclosure can be employed for purchasing and redeeming such various other draw lottery tickets.

Additionally, for a better understanding of the present disclosure, various known systems and methods employed for purchasing draw lottery tickets are also now described.

In a first example known lottery ticket system for purchasing a draw lottery ticket for a draw lottery game in person, a player selects the player numbers for the draw lottery ticket and the player fills out a paper play slip with the player's selected numbers. The player hands that play slip to an operator of a lottery terminal and the operator causes the operator uses a lottery terminal including a contact image sensor (CIS) reader to scan the paper play slip. The CIS reader of the lottery terminal creates play slip scan data for the play of the draw lottery game. The CIS reader provides the play slip scan data to the terminal application of the lottery terminal. The terminal application of the lottery terminal interprets and uses that play slip scan data to create a draw lottery ticket including the player numbers. The lottery terminal and specifically the terminal application causes a lottery ticket printer to print out the draw lottery ticket with the player numbers. The lottery ticket printer can be part of the lottery terminal or separate from but connected to the lottery terminal. The operator of the lottery terminal also collects the payment for the draw lottery ticket and provides the printed draw lottery ticket to the player. It should be appreciated that in certain such systems, the lottery terminal includes the CIS reader and the lottery ticket printer in one cabinet. In other systems, the CIS reader and/or the lottery ticket printer can be separate from the lottery terminal cabinet and connected to the lottery terminal by suitable wires.

In a slight variation of this first example known lottery ticket system and method for purchasing a draw lottery ticket for a draw lottery game in person, a player does not select the player numbers for the draw lottery ticket and the player marks a paper play slip with an indication of a requested quick pick for the player numbers. The player hands that play slip to an operator of a lottery terminal and the operator uses a lottery terminal including a CIS reader to scan the paper play slip. The CIS reader of the lottery terminal creates play slip scan data for the play of the draw lottery game. The CIS reader provides the play slip scan data to the terminal application of the lottery terminal. The terminal application of the lottery terminal interprets and uses that play slip scan data to create a draw lottery ticket including the player numbers. In this case, the lottery terminal randomly generates the player numbers. The lottery terminal and specifically the terminal application causes a lottery ticket printer to print out the draw lottery ticket with the player numbers. The lottery ticket printer can be part of the lottery terminal or separate from but connected to the lottery terminal. The operator of the lottery terminal also collects the payment for the draw lottery ticket and provides the printed draw lottery ticket to the player.

In a second example known lottery ticket system and method for purchasing a draw lottery ticket for a draw lottery game in person, a player does not fill out a paper play slip with the player's selected numbers, but rather the player tells the operator of a lottery terminal that the player wants to purchase a draw lottery ticket using a quick pick for a draw lottery game and the operator inputs that request into the lottery terminal (via an operator interface of the lottery terminal). The lottery terminal randomly determines the player numbers for the player's lottery ticket for the play of the lottery game and uses those numbers to create a draw lottery ticket. The lottery terminal then causes a lottery ticket printer to print out the draw lottery ticket with the player numbers. The lottery ticket printer can be part of the lottery terminal or separate from but connected to the lottery terminal. The operator of the lottery terminal also collects the payment for the draw lottery ticket and provides the printed draw lottery ticket to the player.

In a third example known lottery ticket system and method for purchasing a draw lottery ticket for a draw lottery game in person, a player uses a suitable application on a player's computer such as a player mobile electronic device (such as a smartphone) to fill out an electronic play slip displayed by the player's computer with the player's selected numbers for the draw lottery game or a quick pick. The application creates a barcode displayable by the display device of the player mobile electronic device. The player causes their mobile electronic device to display the barcode such that a CIS reader of a lottery terminal having a barcode scanner scans the barcode and creates player slip scan data representing the player numbers or the quick pick for the play of the draw lottery game. The CIS reader sends the player slip scan data to a terminal application of the lottery terminal, and the terminal application uses that player slip scan data to create a draw lottery ticket including the player numbers (respectively either selected by the player or randomly selected by the lottery terminal). The lottery terminal causes a lottery ticket printer to print out the draw lottery ticket with the player numbers. The operator of the lottery terminal also collects the payment for the draw lottery ticket and provides the printed draw lottery ticket to the player.

In a fourth example known lottery ticket system and method for purchasing a draw lottery ticket for a draw lottery game remotely (from any lottery terminal), a player uses their computer such as a player mobile electronic device (such as a smartphone) to access a web site to fill out an electronic play slip with the player numbers (selected by the player or randomly selected by the web site) for the draw lottery game. The web site functions with a lottery host system to create a draw lottery ticket including the player numbers. The web site also functions with a lottery host system to obtain payment for the draw lottery ticket including the player numbers. The lottery host system creates a virtual draw lottery ticket with the player numbers for the player and sends that virtual draw lottery ticket to an email address of the player. This fourth example known system does not include any lottery terminal (or CIS reader thereof).

This fourth example known lottery ticket system is only legal in a limited quantity of jurisdictions (such as states in the United States) that permit the purchase of draw lottery tickets via such completely remote and electronic systems and methods.

In various other jurisdictions (such as other states) that do not permit such completely remote and electronic purchase of draw lottery tickets (such as via the above described fourth example known system and method), a fifth example known lottery ticket system using a courier service has been employed. This fifth example known lottery ticket system and method has been used to enable players to remotely electronically purchase draw lottery tickets for draw lottery games wherein the courier service conducts various physical steps of the lottery ticket purchase process on behalf of the players. More specifically, in this fifth example known system and method for purchasing a draw lottery ticket for a draw lottery game remotely from any lottery terminal, a player uses a suitable application on their mobile electronic device (such as mobile telephone) to purchase a draw lottery ticket (which can include the player inputting the player's selected numbers or a quick pick indication for the draw lottery game). This application is often referred to as a courier mobile application. The courier mobile application functions to create lottery ticket purchase data (including the player's selected numbers or the quick pick numbers that the courier mobile application randomly selected) and causes the player's mobile electronic device to send the lottery ticket purchase data via a data network to a courier server at a courier processing center. The courier server uses the received lottery ticket purchase data to create and cause a courier printer to physically print a physical paper play slip for the play of the draw lottery game at the courier processing center. The play slip includes the player numbers. A human courier processing clerk takes the physical printed paper play slip for the play of the draw lottery game to an operator of a lottery terminal at a physical location of the lottery terminal that is remote from the courier processing center. The operator uses the lottery terminal (which includes a CIS reader) to scan the physical printed paper play slip. The CIS reader creates play slip scan data for the draw lottery ticket, and the terminal application of the lottery terminal uses that play slip scan data to determine the player numbers for the play of the draw lottery game and to create the lottery ticket (such as in the same manner as described above for the first example). The lottery terminal causes a lottery ticket printer to print out the draw lottery ticket with the player numbers. The operator of the lottery terminal also collects the payment for the draw lottery ticket from the courier processing clerk and provides the printed draw lottery ticket to the courier processing clerk. The courier processing clerk then takes the physical printed play slip and the physical printed draw lottery ticket back to the courier processing center. The courier processing clerk scans the physical printed draw lottery ticket using a courier scanning system connected to the courier server. The courier server links the scanned draw lottery ticket back to a player account established through the courier mobile application. The courier server then makes the scanned draw lottery ticket available for the player to view via the courier mobile application on the player's mobile electronic device. The courier processing clerk places the physical printed play slip and the physical printed draw lottery ticket in secure courier storage locations for storage if needed at a later time. After the draw for the play of the draw lottery game takes place, if the player's draw lottery ticket is a winning draw lottery ticket and the winning amount is less than $600, the courier server automatically credits the winning amount for the player's draw lottery ticket to the player's account. The courier service can then retrieve and redeem the stored actual winning physical printed draw lottery ticket at a location having a lottery terminal. After the draw for the draw lottery game takes place, if the player's draw lottery ticket is a winning lottery ticket and the winning amount is $600 or more, a courier processing clerk retrieves the stored winning physical player draw lottery ticket from the courier storage location and sends that physical printed draw lottery ticket to the player so that the player can cash in that draw lottery ticket and obtain the winning amount.

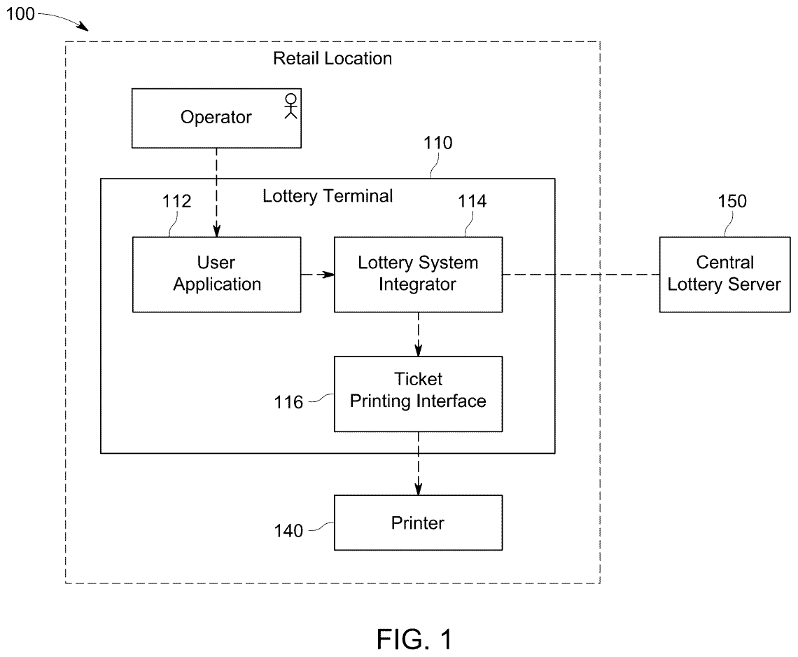

FIG. 1 shows parts of a sixth known lottery ticket selling system 100. This lottery ticket selling system 100 includes: (a) a lottery terminal 110; (b) a lottery ticket printer 140; and (c) a central lottery server 150.

The lottery terminal 110 includes a processor and a memory (not shown). The lottery terminal 110 is configured to generate draw lottery tickets and cause the lottery ticket printer 140 to print the draw lottery tickets. The lottery terminal 110 includes: (a) a user application 112; (b) a lottery system integrator 114; and (c) a ticket printing interface 116. Each of the user application 112, the lottery system integrator 114, and the ticket printing interface 116 include instructions stored in the memory of the lottery terminal 110.

The lottery ticket printer 140 can include: (a) a printer housing (not shown); (b) a supply paper holder (not shown); (c) a plurality of roll engagers (not shown) supported by the printer housing; and (d) a controller (not shown). The example lottery ticket printer 140 is configured to receive ticket printer data from the lottery terminal 110 and process the ticket printer data to print one or more draw lottery tickets.

The central lottery server 150 includes a processor and a memory (not shown). The memory includes instructions that when executed by the processor cause and/or configure the processor to provide functionality as described herein. The central lottery server 150 is a member of a suitable lottery central system. The central lottery server 150 is configured for one or more of processing of draw game wager requests for draw lottery tickets, processing of ticket redemption requests for lottery tickets, and other lottery ticket related functionality.

On the lottery terminal 110, the user application 112 enables an operator (such as a player or a clerk) to purchase a draw lottery ticket (which can include the player inputting the player's selected numbers or a quick pick indication for the draw lottery game) and/or other lottery ticket related functionality. The user application 112 provides lottery ticket data (such as including the player's selected numbers, player numbers randomly selected by the lottery terminal 110, and/or the quick pick indication) to the lottery system integrator 114 to facilitate the purchase of the draw lottery ticket. In this example, the user application 112 is configured to process ticket information based on a play slip for purchasing and printing of draw lottery ticket(s) associated with the play slip. The play slip can be a physical paper play slip, digital play slip data, and/or an electronic play slip that includes the player's selected numbers (or quick pick indication), as described above.

The lottery system integrator 114 facilitates communication between the lottery terminal 110 and the central lottery server 150. In this example, the lottery system integrator 114 employs an application programming interface that is specific to the central lottery server 150 for authentication of the lottery terminal 110, authorization of ticket purchases, and/or other lottery ticket related functionality.

With the lottery ticket data, the lottery system integrator 114 generates and sends a draw lottery ticket request to the central lottery server 150. The draw lottery ticket request includes the player's selected numbers, player numbers randomly selected by the lottery terminal 110, and/or the quick pick indication.

The central lottery server 150 employs the draw lottery ticket request to facilitate the purchase of the draw lottery ticket. The central lottery server 150 generates the draw lottery ticket using one of the player's selected numbers, the player numbers randomly selected by the lottery terminal, or player numbers randomly selected by the central lottery server 150 (e.g., responsive to the quick pick indication). The central lottery server 150 generates a draw lottery ticket response that enables the purchased draw lottery ticket to be printed by the lottery terminal 110.

The ticket printing interface 116 is configured to cause a draw lottery ticket to be printed by the lottery ticket printer 140. In this example, the ticket printing interface 116 generates ticket printer data for the lottery ticket printer 140 based on the draw lottery ticket response.

Although the sixth known lottery ticket selling system 100 enables a player to purchase a lottery ticket and to receive a printed lottery ticket, the player (or a courier clerk acting on behalf of the player) must be physically present at the lottery terminal 110 to purchase the lottery ticket.

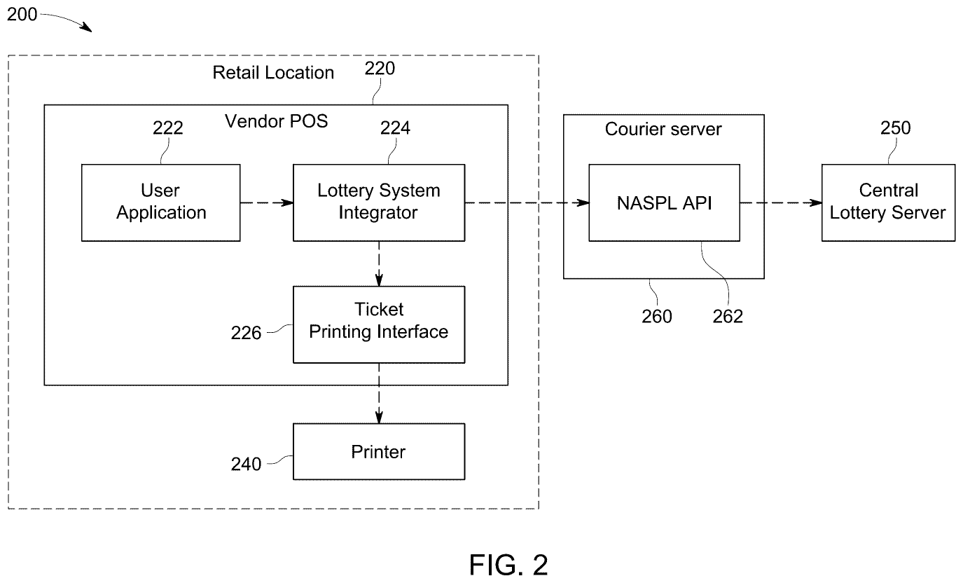

FIG. 2 shows a seventh known lottery ticket selling system 200. This known system includes: (a) a vendor point of sale (POS) device 220; (b) a lottery ticket printer 240; (c) a central lottery server 250; and (d) a courier server 260.

The vendor POS device 220 includes a cash register, a tablet or other computing device with point of sale functionality. In this example, the vendor POS device 220 is located in a checkout lane of a retail location. The vendor POS device 220 includes a processor and a memory (not shown). The vendor POS device 220 is configured to facilitate the purchase of draw lottery tickets and cause the lottery ticket printer 240 to print the draw lottery tickets. In the example shown in FIG. 2, the vendor POS device 220 includes: (a) a user application 222; (b) a lottery system integrator 224; and (c) a ticket printing interface 226. In this example, each of the user application 222, the lottery system integrator 224, and the ticket printing interface 226 include instructions stored in the memory of the vendor POS device 220.

The example lottery ticket printer 240 can include: (a) a printer housing (not shown); (b) a supply paper holder (not shown); (c) a plurality of roll engagers (not shown) supported by the printer housing; and (d) a controller (not shown). The example lottery ticket printer 240 is configured to receive ticket printer data from the vendor POS device 220 and process the ticket printer data to print one or more draw lottery tickets.

The central lottery server 250 includes a processor and a memory (not shown). The memory includes instructions that when executed by the processor cause and/or configure the processor to provide functionality as described herein. In this example, the central lottery server 250 is a member of a suitable lottery central system. The central lottery server 250 is configured for one or more of processing of draw lottery ticket requests for draw lottery tickets, processing of ticket redemption requests for draw lottery tickets, and other lottery ticket related functionality.

The courier server 260 includes a processor and a memory (not shown). The memory includes instructions that when executed by the processor cause and/or configure the processor to provide functionality as described herein. The courier server 260 includes and/or supports a suitable application programming interface (API), such as a North American Association of State and Provincial Lotteries (NASPL) API 262, for communication with the vendor POS device 220 and/or the central lottery server 250.

The courier server 260 is configured to receive lottery ticket purchase data from the vendor POS device 220 and to send the lottery ticket purchase data to the central lottery server 250. In various embodiments, the lottery ticket purchase data includes or is based on a suitable play slip for the draw lottery game. The courier server 260 is configured to enable a courier service, for example, to deposit funds to a player account, to withdraw funds from the player account, and to use funds in the player account to purchase a lottery ticket for a draw lottery game.

On the vendor POS device 220, the user application 222 enables an operator (such as a checkout clerk) to purchase a draw lottery ticket for a player (which can include the player inputting the player's selected numbers or a quick pick indication for the draw lottery game). The user application 222 provides lottery ticket data (such as including the player's selected numbers, player numbers selected by the vendor POS device 220, or the quick pick indication) to the lottery system integrator 224 to facilitate the purchase of the draw lottery ticket. In this example, the user application 222 is configured to process ticket information based on scanned bar code data associated with a draw lottery ticket to be purchased (such as based on a hang tag available to a clerk using the vendor POS device 220).

With the lottery ticket data, the lottery system integrator 224 generates and sends a draw lottery ticket request to the courier server 260. The lottery system integrator 224 employs a suitable application programming interface (API), such as a North American Association of State and Provincial Lotteries (NASPL) API 262, for communication with the courier server 260. In this example, the draw lottery ticket request includes the player's selected numbers, the player numbers selected by the vendor POS device 220, or the quick pick indication.

The courier server 260 sends the draw lottery ticket request (or data based on the draw lottery ticket request) to the central lottery server 250 to enable purchasing of the draw lottery ticket. In this example, the courier server 260 uses the NASPL API for communication with the central lottery server 250.

The central lottery server 250 employs the draw lottery ticket request to facilitate the purchase of the draw lottery ticket. The central lottery server 250 generates a draw lottery ticket response that enables the purchased draw lottery ticket to be printed by the vendor POS device 220. In this example, the draw lottery ticket response includes a security code that facilitates authentication of the printed draw lottery ticket. The security code is to be printed on the draw lottery ticket. The central lottery server 250 sends the draw lottery ticket response to the vendor POS device 220 via the courier server 260.

On the vendor POS device 220, the ticket printing interface 226 is configured to cause a draw lottery ticket to be printed by the lottery ticket printer 240. In this example, the ticket printing interface 226 generates ticket printer data based on the draw lottery ticket response for the lottery ticket printer 240. The ticket printer data includes data and/or instructions that cause the lottery ticket printer 240 to print onto a blank paper thereby creating a printed draw lottery ticket.

Although the seventh known lottery ticket selling system 200 enables a player to purchase a lottery ticket and to receive a printed lottery ticket, the player (or a courier clerk acting on behalf of the player) must be physically present at the vendor POS device 220 to purchase the lottery ticket.

Various embodiments of the present disclosure provides a draw lottery ticket selling system and method that improves upon the above described courier service processes and overcomes numerous of these disadvantages while still providing many of the advantages of the courier service processes, and while expected to be permitted by the various state lotteries that permit such courier services.

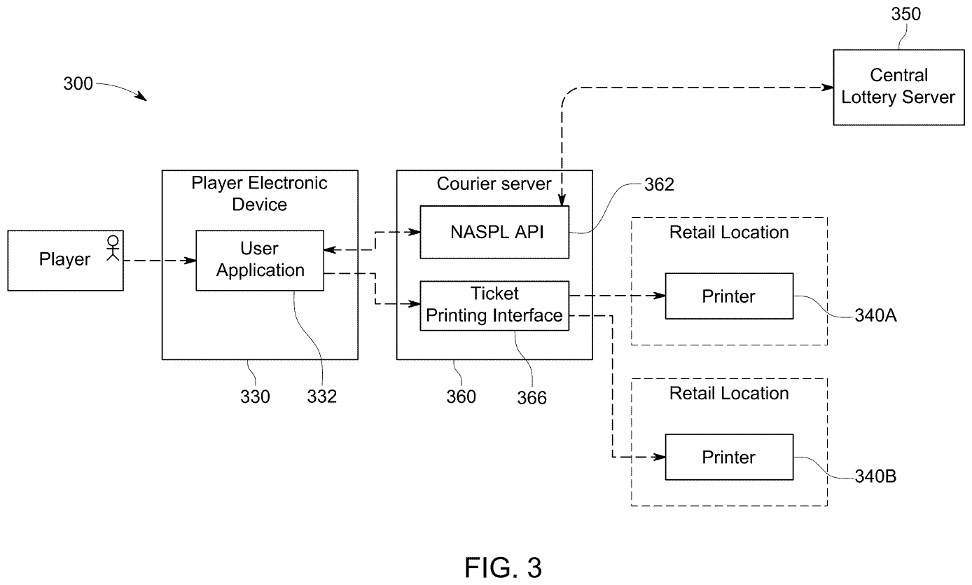

FIG. 3 illustrates an example draw lottery ticket selling system 300 of one example embodiment of the present disclosure.

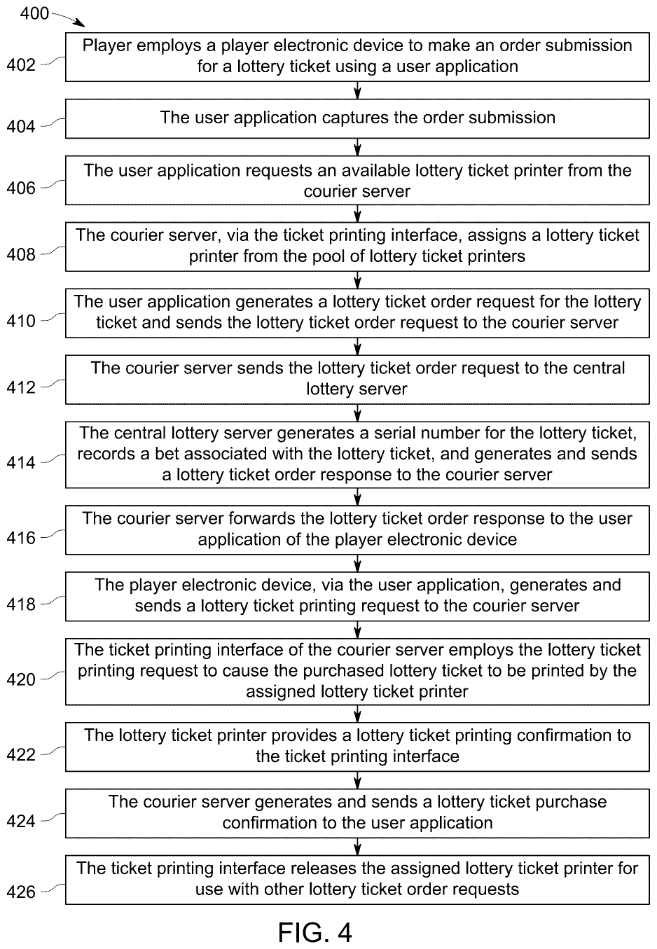

FIG. 4 illustrates an example method 400 of operating the example draw lottery ticket selling system 300 in accordance with one example embodiment of the present disclosure.

More specifically, this illustrated example embodiment of the present disclosure provides a draw lottery ticket selling system 300 including: (a) a player electronic device 330 with a user application 332 downloaded thereon; (b) a pool of lottery ticket printers 340; (c) a central lottery server 350; and (d) a courier server 360.

Various embodiments of the present disclosure are directed to the courier server 360 itself and methods of operation thereof.

Various embodiments of the present disclosure are directed to the courier server 360 and the pool of lottery ticket printers 340, and methods of operation thereof.

Various other embodiments of the present disclosure are directed to the player electronic device 330 and methods of operation thereof.

Various other embodiments of the present disclosure are directed to the player electronic device 330 and the courier server 360 and methods of operation thereof.

Various other embodiments of the present disclosure are directed to the player electronic device 330, the pool of lottery ticket printers 340, and the courier server 360, and methods of operation thereof.

In this illustrated example embodiment, the player electronic device 330 and the courier server 360 are configured to communicate with each other via a suitable data network (not shown) such as but not limited to a cellular data network or the Internet.

In this illustrated example embodiment, the courier server 360 and the central lottery server 350 are configured to communicate with each other via a suitable data network (not shown) such as a cellular data network, the Internet, or a private secure network. The courier server 360 and the pool of lottery ticket printers 340 are configured to communicate with each other via a suitable data network (not shown) such as a cellular data network, the Internet, or a private secure network.

The player electronic device 330 with the user application 332 downloaded thereon can be any suitable device such as an electronic smartphone, an electronic tablet, an electronic watch, or other suitable electronic computing device with suitable data communication, user input, and display functions. The player electronic device 330 includes a processor and a memory (not shown). The memory includes instructions that when executed by the processor cause and/or configure the processor to provide functionality as described herein. In various embodiments, the user application 332 includes instructions stored in the memory of the player electronic device 330. In various embodiments, all or a portion of the functionality of the user application 332 can be implemented using application-specific integrated circuits or other suitable hardware.

The user application 332 enables a user of the player electronic device 330 to purchase a draw lottery ticket and obtain that purchased draw lottery ticket. In various embodiments, the user obtains the purchased draw lottery ticket as a printed draw lottery ticket and/or digital (or virtual) draw lottery ticket. In various embodiments, the user application 332 includes a courier mobile application such as the courier mobile application as described above in connection with the fifth example or any other suitable courier mobile application. The user application 332 is configured to enable a player to use the user application 332 on the player electronic device 330 to set up a player account with the courier service (such as provided by the courier server 360), to deposit funds to the player account, to withdraw funds from the player account, and to use funds in the player account to purchase a lottery ticket for a draw lottery game. In various embodiments, the user application 332 enables the player to input the player's selected numbers or a quick pick indication for the draw lottery ticket for the draw lottery game that the player wishes to purchase and thus play (such as by interacting with a graphical user interface, scanning a new or previously used play slip, or identifying a previously purchased draw lottery ticket with player numbers for repurchase). The user application 332 functions on the player electronic device 330 to create a lottery ticket order request (including the player selected numbers, player numbers selected by the player electronic device 330, or the quick pick indication) and cause the player electronic device 330 to send the lottery ticket order request to the courier server 360.

In various embodiments and/or scenarios, the user application 332 generates the lottery ticket order request to include: (1) ticket information for a single draw lottery ticket; (2) ticket information for multiple draw lottery tickets for a same lottery game and for a same user; and/or (3) ticket information for multiple draw lottery tickets for different lottery games for a same user. In other words, the lottery ticket order request can be associated with one, two, three, or more draw lottery tickets for one, two, three or more draw lottery games.

In various embodiments, the pool of lottery ticket printers 340 includes: (1) standalone lottery ticket printers; (2) lottery ticket printers associated with a central lottery server (such as, the central lottery server 350); (3) lottery ticket printers associated with a lottery terminal (such as the lottery ticket printer 140 associated with the lottery terminal 110); (4) lottery ticket printers associated with a point of sale device (such as the lottery ticket printer 240 associated with the vendor POS device 220; (5) lottery ticket printers associated with a courier service (such as for printing play slips and/or lottery tickets); and/or (6) other suitable printers.

In the example embodiment shown in FIG. 3, the pool of lottery ticket printers 340 includes two lottery ticket printers 340A and 340B located at different retail locations (i.e., geographically distributed). For brevity, only the lottery ticket printer 340A is described in detail. The lottery ticket printer 340A includes: (a) a printer housing (not shown); (b) a supply paper holder (not shown); (c) a plurality of roll engagers (not shown) supported by the printer housing; and (d) a controller (not shown). The lottery ticket printer 340A is configured to print lottery tickets. In various embodiments, the lottery ticket printer 340A receives a lottery ticket printing request (or lottery ticket image) associated with a draw lottery ticket and prints that draw lottery ticket. In various such embodiments, the lottery ticket printer 340A receives the lottery ticket printing request from the player electronic device 330 and/or the courier server 360.

The central lottery server 350 includes a processor and a memory (not shown). The memory includes instructions that when executed by the processor cause and/or configure the processor to provide functionality as described herein. In various embodiments, the central lottery server 350 is a member of a suitable lottery central system. The central lottery server 350 is configured for one or more of processing of lottery ticket order requests for draw lottery tickets, randomly selecting draw numbers for a play of a draw lottery game, processing of lottery ticket redemption requests for draw lottery tickets, and other lottery ticket related functionality. In various embodiments, the central lottery server 350 generates the draw lottery ticket using one of the player's selected numbers, player numbers randomly selected by the player electronic device 330, player numbers randomly selected by the courier server 360, or player numbers randomly selected by the central lottery server 350 (e.g., responsive to the quick pick indication). In various embodiments, the central lottery server 350 generates and sends a suitable lottery ticket order response in response to a lottery ticket order request. The lottery ticket order response includes a confirmation of the purchase of the draw lottery ticket (such as a serial number, player numbers, and/or other identifier), a security code that facilitates authentication of the draw lottery ticket when printed, and/or other suitable ticket information.

The courier server 360 is located at a suitable courier processing center (not shown). In various embodiments, the courier server 360 is configured to enable a courier service, for example, to deposit funds to a player account, to withdraw funds from the player account, and to use funds in the player account to purchase a draw lottery ticket for a lottery game. The courier server 360 includes a processor and a memory (not shown) including instructions that when executed by the processor cause and/or configure the processor to provide at least the functionality as described herein. In various embodiments, the courier server 360 includes and/or hosts a suitable lottery ticket purchasing interface or API, such as a NASPL API 362, for communication with the player electronic device 330 and/or the central lottery server 350. In various embodiments, the NASPL API 362 also enables communication with a lottery terminal (such as the lottery terminal 110) and/or a vendor POS device, such as the vendor POS device 220. In various embodiments, the courier server 360 randomly selects player numbers for a draw lottery ticket responsive to a quick pick indication.

In various embodiments, the courier server 360 includes a ticket printing interface 366. The ticket printing interface 366 is configured to: (1) assign a lottery ticket printer (such as from the pool of lottery ticket printers 340); (2) cause a draw lottery ticket to be printed by the assigned lottery ticket printer; and/or (3) generate a lottery ticket purchase confirmation to provide an indication to a player that a draw lottery ticket has been purchased. In various embodiments, the ticket printing interface 366 authorizes individual lottery ticket printers and/or groups of lottery ticket printers for inclusion within the pool of lottery ticket printers 340. In various embodiments, the ticket printing interface 366 tracks and/or monitors printer information associated with the pool of lottery ticket printers 340, for example, to determine availability within the pool of lottery ticket printers 340 to print a draw lottery ticket. For each lottery ticket printer of the pool of lottery ticket printers 340, the printer information can include: (1) a location of that lottery ticket printer (such as street address, GPS coordinates, or an in-store map); (2) identifiers associated with which draw lottery tickets able to be printed by that lottery ticket printer; (3) printing supply levels associated with that lottery ticket printer (such as paper levels or ink levels); and (4) a print queue size (or estimated wait time) associated with that lottery ticket printer; and/or other suitable printer information.

In various embodiments, the courier server 360 is modified from the known courier server (described above). Specifically, the courier server 360 is modified to enable a separation in location and/or timing between purchasing a draw lottery ticket and printing of that draw lottery ticket. In various embodiments, the courier server 360 enables the purchase at a first location using a first device and the printing at a second, different location using a second, different device. In various such embodiments, the courier server 360 enables a player to purchase a draw lottery ticket using their personal electronic device, such as a smartphone or tablet, wherever the player is currently located and cause the draw lottery ticket to be printed at a lottery ticket printer located at a retail location, such as a grocery store or convenience store. In some such embodiments, the courier server 360 enables the player to purchase the draw lottery ticket from their home, while on a train during their commute, or while waiting in line at a store (such as not yet at the location of a lottery ticket printer) and pick up the printed draw lottery ticket from a remote, but convenient location (such as at a checkout lane in which they have been waiting to make a purchase or at which they plan to visit on their way to work). In various embodiments, the courier server 360 enables functionality for purchasing draw lottery tickets to be distributed among many player electronic devices (e.g., player electronic device 330), when such functionality was previously limited to lottery terminals and vendor POS devices.

In various embodiments, the courier server 360 enables the purchase of the draw lottery ticket at a first time and the printing of the draw lottery ticket at a second, subsequent time. In other words, the courier server 360 reduces wait times and/or queues associated with purchasing and/or obtaining a draw lottery ticket. In some such embodiments, the courier server 360 enables the player to purchase the draw lottery ticket at a convenient time, such as before leaving their home or arriving at a retail location at which the draw lottery ticket will be printed. In some such embodiments, the courier server 360 enables the player to complete a purchase of the draw lottery ticket, but postpone printing of the purchased draw lottery ticket until the convenient time. In other words, the player can choose a convenient time at which the draw lottery ticket is printed (such as in five minutes, in three hours, at a specific time and/or day, etc.), instead of simply waiting for the draw lottery ticket to be printed after its purchase at a lottery terminal. In some embodiments, the user application 332 and/or the courier server 360 employ location tracking of the player electronic device 330 (such as via GPS built into the player electronic device 330) to estimate when the player will arrive at the lottery ticket printer and cause the draw lottery ticket to be printed upon or just before their arrival. In some embodiments, the courier server 360 enables the player to avoid printing the draw lottery ticket altogether, for example, if the draw lottery ticket is not a winning ticket.

In various embodiments, the courier server 360 enables the use of a lottery ticket purchasing interface by a player electronic device. In certain such embodiments, player electronic devices and vendor POS devices are both able to employ a lottery ticket purchasing interface traditionally used only by vendor POS devices.

Turning now to FIG. 4, an example method 400 of operating the draw lottery ticket selling system 300 is now described. Although the method is described with reference to the flowchart shown in FIG. 4, other methods of performing the acts associated with this illustrated process may be employed. For example, the order of certain of the illustrated blocks and diamonds may be changed, certain of the illustrated blocks and diamonds may be optional, or certain of the illustrated blocks and diamonds may not be employed.

The player electronic device 330 enables the player to make an order submission for a draw lottery ticket using the user application 332, as indicated at block 402. For example, the player interacts with a graphical user interface of the user application 332 to indicate player numbers, a quick pick indication, and/or other suitable ticket information for the draw lottery ticket.

The user application 332 captures the order submission, as indicated at block 404. In various embodiments, the user application 332 confirms the order submission, verifies available funds for purchase of the draw lottery ticket, etc.

After the order submission, the user application 332 requests an available lottery ticket printer from the courier server 360, as indicated at block 406. In various embodiments, the user application 332 sends a printer assignment request to the courier server 360. In various embodiments, the printer assignment request indicates a time and/or geographic location selected by the player.

Responsive to the printer assignment request, the courier server 360, via the ticket printing interface 366, assigns a lottery ticket printer from the pool of lottery ticket printers 340, as indicated at block 408. In various embodiments, the ticket printing interface 366 assigns the lottery ticket printer based on the tracked printer information, described above. In this example embodiment, the ticket printing interface 366 assigns the lottery ticket printer 340A, which is geographically closest to the player electronic device 330 and has sufficient ink and paper for printing. The ticket printing interface 366 generates and sends a printer assignment response to the user application 332. In various embodiments, the printer assignment response includes: (1) an identifier associated with the assigned lottery ticket printer 340A; (2) a location of the assigned lottery ticket printer 340A (such as a street address or an in-store map); (3) an authorization code usable by the lottery ticket printer 340A to authorize printing for the player electronic device 330; and/or (4) other suitable information.

The user application 332 generates a lottery ticket order request for the draw lottery ticket and sends the lottery ticket order request to the courier server 360 (such as via the NASPL API 362), as indicated at block 410. In various embodiments, the lottery ticket order request includes the player's selected numbers, the player numbers randomly selected by the player electronic device 330, the quick pick indication, and/or other suitable ticket information for the draw lottery ticket.

The courier server 360 sends the lottery ticket order request to the central lottery server 350, as indicated at block 412. In various embodiments, the courier server 360 forwards the lottery ticket order request received from the user application 332 using the NASPL API 362. In various embodiments, the courier server 360 randomly selects player numbers for the draw lottery ticket responsive to the quick pick indication within the lottery ticket order request and modifies the lottery ticket order request to include the randomly selected player numbers.

Responsive to the lottery ticket order request, the central lottery server 350 generates a serial number for the draw lottery ticket, records a bet associated with the draw lottery ticket, and generates and sends a lottery ticket order response to the courier server 360, as indicated at block 414. In various embodiments, the central lottery server 350 generates the draw lottery ticket using one of the player's selected numbers, player numbers randomly selected by the player electronic device 330, player numbers randomly selected by the courier server 360, or player numbers randomly selected by the central lottery server 350 (e.g., responsive to the quick pick indication). The lottery ticket order response can include a confirmation of the purchase of the draw lottery ticket, a security code that facilitates authentication of the draw lottery ticket when printed, and/or other suitable ticket information, as described above. In various embodiments, the courier server 360 receives the lottery ticket order response from the central lottery server 350 using the NASPL API 362.

The courier server 360 forwards the lottery ticket order response to the user application 332 of the player electronic device 330, as indicated at block 416.

The player electronic device 330, via the user application 332, generates and sends a lottery ticket printing request to the courier server 360, as indicated at block 418. In various embodiments, the lottery ticket printing request includes the printer assignment response (such as identifying the assigned lottery ticket printer 340A) and the lottery ticket order response.

The ticket printing interface 366 of the courier server 360 employs the lottery ticket printing request to cause the purchased draw lottery ticket to be printed by the assigned lottery ticket printer 340A, as indicated at block 420. In various embodiments, the ticket printing interface 366 generates a lottery ticket image for the draw lottery ticket based on the lottery ticket printing request and sends the lottery ticket image to the assigned lottery ticket printer 340A. After the assigned lottery ticket printer 340A prints the draw lottery ticket, the printed draw lottery ticket can be picked up by the player (or on behalf of the player by a courier processing clerk).

When printing of the draw lottery ticket is complete, the lottery ticket printer 340A provides a lottery ticket printing confirmation to the ticket printing interface 366, as indicated at block 422.

Responsive to the lottery ticket printing confirmation, the courier server 360 generates and sends a lottery ticket purchase confirmation to the user application 332, as indicated at block 424. The lottery ticket purchase confirmation provides an indication to the player that the draw lottery ticket has been purchased and printed. In various embodiments, the lottery ticket purchase confirmation includes the lottery ticket image, another suitable digital representation of the draw lottery ticket, the player numbers of the draw lottery ticket, and/or other ticket information. The user application 332 is configured to display the lottery ticket image or other ticket information based on the lottery ticket purchase confirmation.

After printing of the draw lottery ticket, the ticket printing interface 366 releases the assigned lottery ticket printer 340A for use with other lottery ticket order requests, as indicated at block 426.

In the example embodiment described above, the courier server 360 forwards the lottery ticket order response to the user application 332 of the player electronic device 330. In certain other embodiments, the courier server 360 does not provide the lottery ticket order response to the user application 332. In certain such embodiments, the courier server 360 provides the lottery ticket purchase confirmation to the user application 332, but holds back the lottery ticket order response. In some such embodiments, the lottery ticket order response includes proprietary and/or secure information and by holding back the lottery ticket order response, the user application 332 (and thus the player electronic device 330) does not receive such proprietary and/or secure information and the courier server 360 enables improved security for such information.

In the example embodiment described above, the user application 332 generates the lottery ticket printing request. In certain other embodiments, the ticket printing interface 366 generates the lottery ticket printing request instead of the user application 332. In some such embodiments, the lottery ticket printing request includes the lottery ticket image and the ticket printing interface 366 provides the lottery ticket printing request to the user application 332. In certain such embodiments, the user application 332 is configured to: (1) immediately send the lottery ticket printing request to the assigned lottery ticket printer 340A; and/or (2) postpone sending the lottery ticket printing request to the assigned lottery ticket printer 340A. For example, the user application 332 is configured to send the lottery ticket printing request to the assigned lottery ticket printer 340A based on a print request received from the user of the player electronic device 330 (such as by providing user inputs to request that the draw lottery ticket be printed). In some such embodiments, the user application 332 on the player electronic device 330 is enabled to print the draw lottery ticket at a convenient time for the player without further interaction with the courier server 360. In various embodiments, the print request includes: (1) a requested time at which the draw lottery ticket should be printed; (2) a requested time at which the printed draw lottery ticket can be picked up; and/or (3) a location at which the draw lottery ticket can be picked up (e.g., a street address, retail location, or other geographic location).

In various embodiments in which the ticket printing interface 366 generates the lottery ticket printing request, the ticket printing interface 366 stores the lottery ticket printing request for a subsequent use. In certain such embodiments, the ticket printing interface 366 provides the lottery ticket purchase confirmation to the user application 332 but does not immediately print the draw lottery ticket. In various embodiments, the ticket printing interface 366 sends the lottery ticket printing request to the lottery ticket printer 340A responsive to a print request received from the user of the player electronic device 330 (such as via the user application 332). In various embodiments, the ticket printing interface 366 sends the lottery ticket printing request to the lottery ticket printer 340A after an outcome of the draw lottery game has been determined (e.g., by the central lottery server 350 randomly selecting draw numbers for a play of the draw lottery game). In certain such examples, the ticket printing interface 366 sends the lottery ticket printing request to the lottery ticket printer 340A after a winning ticket printing condition has been met. In some examples, the winning ticket printing condition is met if the draw lottery ticket is determined to be a winning lottery ticket. In some examples, the winning ticket printing condition is met if the draw lottery ticket is determined to be a winning lottery ticket and the winning amount is above a predetermined threshold (e.g., $600 or more). In various embodiments, the ticket printing interface 366 prevents the draw lottery ticket from being printed when the winning ticket printing condition has not been met. In these embodiments, after the outcome of the draw lottery game is determined and the draw lottery ticket is determined to not be a winning draw lottery ticket, the draw lottery ticket cannot be printed, which saves printing resources.

In various embodiments, the ticket printing interface 366 sends a plurality of lottery ticket printing requests for different draw lottery tickets to the lottery ticket printer 340A, enabling a courier processing clerk to save time by picking up a plurality of printed winning draw lottery tickets at one time.

In various embodiments, the ticket printing interface 366 assigns a plurality of lottery ticket printers from the pool of lottery ticket printers 340 such that the plurality of lottery ticket printers are co-located within a same facility to enable the plurality of printed winning draw lottery tickets to be printed in parallel (with reduced printing time) and the courier processing clerk to pick up the plurality of printed winning draw lottery tickets at one time.

In various embodiments, the ticket printing interface 366 generates and sends a single ticket printing request associated with a plurality of different draw lottery tickets to an assigned lottery ticket printer to cause the assigned lottery ticket printer to print the plurality of winning lottery tickets.

In various embodiments, the lottery ticket printing request includes one or more restrictions on printing of the draw lottery ticket. In various embodiments, the restrictions include: (1) a time period in which the draw lottery ticket may be printed (such as an expiration date); (2) a list of lottery ticket printers with which the draw lottery ticket may be printed; (3) a quantity of times the draw lottery ticket may be printed; (4) a geographic region in which the draw lottery ticket may be printed; and/or (5) other suitable restrictions.

In various embodiments, the ticket printing interface 366 assigns the lottery ticket printer based on a geographic location associated with the player electronic device 330. In some embodiments, the ticket printing interface 366 assigns the lottery ticket printer based on a current geographic location of the player electronic device 330, for example, to assign a lottery ticket printer that is geographically closest to the player electronic device 330. In some embodiments, the ticket printing interface 366 assigns the lottery ticket printer based on a geographic location selected by a user of the player electronic device 330, for example, to assign a lottery ticket printer near a location at which the user will visit at a subsequent time (e.g., a retail location on their way to work).

Although the example courier server 360 is described in the example embodiment above as a single server, in various other embodiments, the courier server 360 is implemented as a distributed computing system, such as a cloud service or computer cluster.

In various embodiments, the courier server 360 hosts a web site that enables a player to use their computer (such as the player electronic device) to fill out an electronic play slip with the player numbers (selected by the player or randomly selected by the web site) for the draw lottery game. The courier server 360 generates and sends suitable lottery ticket purchase data to the central lottery server 350 to facilitate purchasing of a draw lottery ticket based on the electronic play slip. In certain such embodiments, the courier server 360 provides the functionality of the user application 332 via the hosted web site, alternatively or in addition to the user application 332.

It should be appreciated from the above that these various example embodiments of the present disclosure provide a series of advantages that enable a more efficient purchase of draw lottery tickets (such as reduced time and/or reduced travel by a player to purchase a draw lottery ticket) and/or a reduction in use of paper and printing supplies. The advantages can include but are not limited to the following advantages: (a) the courier service not having to physically handle individual printed draw lottery tickets; (b) reduced usage of lottery terminals and/or vendor POS devices for purchase of draw lottery tickets; (c) improved player convenience when purchasing a draw lottery ticket; (d) player selection of where a draw lottery ticket is printed; and (e) player selection of when a draw lottery ticket is printed.

It should be appreciated from the above that various embodiments of the present disclosure provide a draw lottery ticket selling system comprising a courier server configured to enable a purchase, via a player electronic device, of a draw lottery ticket provided by a central lottery server, wherein the courier server is configured to: (1) receive a request for the draw lottery ticket from the player electronic device; (2) send a request for a purchase of the draw lottery ticket to the central lottery server; (3) receive a purchase response that confirms the purchase of the draw lottery ticket from the central lottery server; (4) assign a lottery ticket printer from a pool of assignable lottery ticket printers to print the draw lottery ticket; and (5) send a purchase confirmation to the player electronic device, the purchase confirmation including a confirmation of the purchase of the draw lottery ticket.

In various such embodiments, the request for the draw lottery ticket comprises an order request captured by a user application based on an order submission from a user of the player electronic device, the user application being executed by the player electronic device, and the courier server is configured to: (a) receive a printer assignment request from the user application of the player electronic device; (b) assign the lottery ticket printer from the pool of assignable lottery ticket printers based on the printer assignment request; (c) send a printer assignment response to the player electronic device, the printer assignment response comprising an identifier associated with the assigned lottery ticket printer; (d) receive the order request from the player electronic device via a North American Association of State and Provincial Lotteries application programming interface (NASPL API); (e) send the request for the purchase of the draw lottery ticket to the central lottery server via the NASPL API; (f) receive the purchase response via the NASPL API, the purchase response comprising bet details associated with the draw lottery ticket and generated by the central lottery server in association with a bet recorded for the draw lottery ticket, the bet details comprising a serial number for the draw lottery ticket; (g) send the purchase response to the user application via the NASPL API; (h) receive a printing request from the user application that comprises the bet details associated with the draw lottery ticket and the identifier associated with the assigned lottery ticket printer; (i) generate a lottery ticket image for the draw lottery ticket based on the bet details; (j) send the lottery ticket image to the assigned lottery ticket printer using the identifier associated with the assigned lottery ticket printer to cause the assigned lottery ticket printer to print the draw lottery ticket using the lottery ticket image; (k) receive a lottery ticket printing confirmation from the assigned lottery ticket printer when printing of the draw lottery ticket is complete; (l) send the lottery ticket image to the user application to enable a display of the lottery ticket image to the user of the player electronic device by the user application; and (m) release the assigned lottery ticket printer.

In various such embodiments, the courier server is configured to cause the assigned lottery ticket printer to print the draw lottery ticket after an outcome of a draw lottery game associated with the draw lottery ticket has been determined.

In various such embodiments, the courier server is configured to cause the assigned lottery ticket printer to print the draw lottery ticket after the draw lottery ticket is determined to be a winning lottery ticket and an amount won associated with the winning lottery ticket is above a predetermined threshold.

In various such embodiments, the courier server is configured to send a lottery ticket printing request associated with a plurality of winning lottery tickets to the assigned lottery ticket printer to cause the assigned lottery ticket printer to print the plurality of winning lottery tickets, wherein the plurality of winning lottery tickets comprise the winning lottery ticket.

In various such embodiments, the courier server is configured to, responsive to a print request received from a user of the player electronic device, cause the assigned lottery ticket printer to print the draw lottery ticket.

In various such embodiments, the purchase confirmation comprises an identifier associated with the assigned lottery ticket printer and a lottery ticket image for the draw lottery ticket.

In various such embodiments, the courier server is configured to: receive a request to print the draw lottery ticket from the player electronic device; assign the lottery ticket printer from the pool of assignable lottery ticket printers responsive to the request to print the draw lottery ticket; and send a printer assignment response to the player electronic device, the printer assignment response comprising an identifier associated with the assigned lottery ticket printer.

In various such embodiments, the courier server is configured to assign the lottery ticket printer based on a geographic location selected by a user of the player electronic device.

In various such embodiments, the courier server is configured to cause the assigned lottery ticket printer to print the draw lottery ticket based on a time selected by a user of the player electronic device.

It should further be appreciated from the above that various embodiments of the present disclosure provide a draw lottery ticket selling system comprising an application programming interface (API) server configured to enable a purchase, via a player electronic device, of a draw lottery ticket provided by a central lottery server. The API server is configured to: (1) receive a request for the draw lottery ticket from the player electronic device; (2) send a request for a purchase of the draw lottery ticket to the central lottery server; (3) receive a response that confirms the purchase of the draw lottery ticket from the central lottery server; (4) send a purchase confirmation to the player electronic device, the purchase confirmation including a confirmation of the purchase of the draw lottery ticket; and (5) cause the draw lottery ticket to be printed after a winning ticket printing condition has been met.

In various such embodiments, the winning ticket printing condition is met if the draw lottery ticket is determined to be a winning lottery ticket and a winning amount is above a predetermined threshold.

In various such embodiments, the application programming interface (API) server is configured to assign a lottery ticket printer from a pool of assignable lottery ticket printers to print the draw lottery ticket.

In various such embodiments, the application programming interface (API) server is configured to assign the lottery ticket printer based on a geographic location selected by a user of the player electronic device.

In various such embodiments, the application programming interface (API) server is configured to prevent the draw lottery ticket from being printed when the winning ticket printing condition has not been met.

In various such embodiments, the application programming interface (API) server is configured to employ a North American Association of State and Provincial Lotteries (NASPL) application programming interface to receive the request for the draw lottery ticket from the player electronic device, send the request for the purchase of the draw lottery ticket to the central lottery server, and receive the response that confirms the purchase of the draw lottery ticket from the central lottery server.

It should further be appreciated from the above that various embodiments of the present disclosure provide a draw lottery ticket selling system comprising a draw lottery ticket server configured to enable a purchase, via a player electronic device, of a draw lottery ticket provided by a central lottery server. The draw lottery ticket server is configured to: (1) receive a request for the draw lottery ticket from the player electronic device; (2) send a request for a purchase of the draw lottery ticket to the central lottery server; (3) receive a response that confirms the purchase of the draw lottery ticket from the central lottery server; and (4) send a purchase confirmation to the player electronic device without printing the draw lottery ticket, the purchase confirmation including a confirmation of the purchase of the draw lottery ticket.

In various such embodiments, the draw lottery ticket server comprises a North American Association of State and Provincial Lotteries application programming interface (NASPL API) that is configured to: (a) receive the request for the draw lottery ticket from the player electronic device, (b) send the request for the purchase of the draw lottery ticket to the central lottery server, and (c) receive the response that confirms the purchase of the draw lottery ticket from the central lottery server; and the draw lottery ticket server comprises a ticket printing interface that is configured to: (i) assign a lottery ticket printer from a pool of assignable lottery ticket printers, the pool of assignable lottery ticket printers comprising lottery ticket printers located at different retail locations, (ii) generate a lottery ticket image for the draw lottery ticket, and (iii) send the lottery ticket image to the assigned lottery ticket printer to cause the assigned lottery ticket printer to print the draw lottery ticket.

In various such embodiments, the purchase confirmation comprises the lottery ticket image for the draw lottery ticket.

In various such embodiments, the draw lottery ticket server is configured to cause the assigned lottery ticket printer to print the draw lottery ticket after a winning ticket printing condition has been met.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

The claims are as follows:

1. A draw lottery ticket selling system comprising:
a courier server configured to enable a purchase, via a player electronic device, of a draw lottery ticket provided by a central lottery server, the courier server comprising a processor and a memory device that stores a plurality of instructions, which when executed by the processor cause the processor to:
receive a request for the draw lottery ticket from the player electronic device;
send a request for a purchase of the draw lottery ticket to the central lottery server;
receive a purchase response that confirms the purchase of the draw lottery ticket from the central lottery server;
assign a lottery ticket printer from a pool of assignable lottery ticket printers to print the draw lottery ticket; and
send a purchase confirmation to the player electronic device, the purchase confirmation including a confirmation of the purchase of the draw lottery ticket.

2. The draw lottery ticket selling system of claim 1, wherein:
the request for the draw lottery ticket comprises an order request captured by a user application based on an order submission from a user of the player electronic device, the user application being executed by the player electronic device;
wherein the plurality of instructions, when executed by the processor, cause the processor to:
receive a printer assignment request from the user application of the player electronic device;
assign the lottery ticket printer from the pool of assignable lottery ticket printers based on the printer assignment request;
send a printer assignment response to the player electronic device, the printer assignment response comprising an identifier associated with the assigned lottery ticket printer;
receive the order request from the player electronic device via a North American Association of State and Provincial Lotteries application programming interface (NASPL API);
send the request for the purchase of the draw lottery ticket to the central lottery server via the NASPL API;
receive the purchase response via the NASPL API, the purchase response comprising bet details associated with the draw lottery ticket and generated by the central lottery server in association with a bet recorded for the draw lottery ticket, the bet details comprising a serial number for the draw lottery ticket;
send the purchase response to the user application via the NASPL API;
receive a printing request from the user application that comprises the bet details associated with the draw lottery ticket and the identifier associated with the assigned lottery ticket printer;
generate a lottery ticket image for the draw lottery ticket based on the bet details;
send the lottery ticket image to the assigned lottery ticket printer using the identifier associated with the assigned lottery ticket printer to cause the assigned lottery ticket printer to print the draw lottery ticket using the lottery ticket image;
receive a lottery ticket printing confirmation from the assigned lottery ticket printer when printing of the draw lottery ticket is complete;
send the lottery ticket image to the user application to enable a display of the lottery ticket image to the user of the player electronic device by the user application; and
release the assigned lottery ticket printer.

3. The draw lottery ticket selling system of claim 1, wherein the plurality of instructions, when executed by the processor, cause the processor to cause the assigned lottery ticket printer to print the draw lottery ticket after an outcome of a draw lottery game associated with the draw lottery ticket has been determined.

4. The draw lottery ticket selling system of claim 1, wherein the plurality of instructions, when executed by the processor, cause the processor to cause the assigned lottery ticket printer to print the draw lottery ticket after the draw lottery ticket is determined to be a winning lottery ticket and an amount won associated with the winning lottery ticket is above a predetermined threshold.

5. The draw lottery ticket selling system of claim 4, wherein the plurality of instructions, when executed by the processor, cause the processor to send a lottery ticket printing request associated with a plurality of winning lottery tickets to the assigned lottery ticket printer to cause the assigned lottery ticket printer to print the plurality of winning lottery tickets, the plurality of winning lottery tickets comprising the winning lottery ticket.

6. The draw lottery ticket selling system of claim 1, wherein the plurality of instructions, when executed by the processor, cause the processor to, responsive to a print request received from a user of the player electronic device, cause the assigned lottery ticket printer to print the draw lottery ticket.

7. The draw lottery ticket selling system of claim 1, wherein the purchase confirmation comprises an identifier associated with the assigned lottery ticket printer and a lottery ticket image for the draw lottery ticket.

8. The draw lottery ticket selling system of claim 1, wherein the plurality of instructions, when executed by the processor, cause the processor to:
receive a request to print the draw lottery ticket from the player electronic device;
assign the lottery ticket printer from the pool of assignable lottery ticket printers responsive to the request to print the draw lottery ticket; and
send a printer assignment response to the player electronic device, the printer assignment response comprising an identifier associated with the assigned lottery ticket printer.

9. The draw lottery ticket selling system of claim 1, wherein the plurality of instructions, when executed by the processor, cause the processor to assign the lottery ticket printer based on a geographic location selected by a user of the player electronic device.

10. The draw lottery ticket selling system of claim 1, wherein the plurality of instructions, when executed by the processor, cause the processor to cause the assigned lottery ticket printer to print the draw lottery ticket based on a time selected by a user of the player electronic device.

11. A draw lottery ticket selling system comprising:
an application programming interface (API) server configured to enable a purchase, via a player electronic device, of a draw lottery ticket provided by a central lottery server, the API server comprising a processor and a memory device that stores a plurality of instructions, which when executed by the processor cause the processor to:
receive a request for the draw lottery ticket from the player electronic device;
send a request for a purchase of the draw lottery ticket to the central lottery server;
receive a response that confirms the purchase of the draw lottery ticket from the central lottery server;
send a purchase confirmation to the player electronic device, the purchase confirmation including a confirmation of the purchase of the draw lottery ticket; and
cause the draw lottery ticket to be printed after a winning ticket printing condition has been met.

12. The draw lottery ticket selling system of claim 11, wherein the winning ticket printing condition is met if the draw lottery ticket is determined to be a winning lottery ticket and a winning amount is above a predetermined threshold.

13. The draw lottery ticket selling system of claim 11, wherein the plurality of instructions, when executed by the processor, cause the processor to assign a lottery ticket printer from a pool of assignable lottery ticket printers to print the draw lottery ticket.

14. The draw lottery ticket selling system of claim 13, wherein the plurality of instructions, when executed by the processor, cause the processor to assign the lottery ticket printer based on a geographic location selected by a user of the player electronic device.

15. The draw lottery ticket selling system of claim 11, wherein the plurality of instructions, when executed by the processor, cause the processor to prevent the draw lottery ticket from being printed when the winning ticket printing condition has not been met.

16. The draw lottery ticket selling system of claim 11, wherein the API server is configured to employ a North American Association of State and Provincial Lotteries (NASPL) application programming interface to receive the request for the draw lottery ticket from the player electronic device, send the request for the purchase of the draw lottery ticket to the central lottery server, and receive the response that confirms the purchase of the draw lottery ticket from the central lottery server.

17. A draw lottery ticket selling system comprising:
a draw lottery ticket server configured to enable a purchase, via a player electronic device, of a draw lottery ticket provided by a central lottery server, the draw lottery ticket server comprising a processor and a memory device that stores a plurality of instructions, which when executed by the processor cause the processor to:
receive a request for the draw lottery ticket from the player electronic device;
send a request for a purchase of the draw lottery ticket to the central lottery server;
receive a response that confirms the purchase of the draw lottery ticket from the central lottery server; and
send a purchase confirmation to the player electronic device without printing the draw lottery ticket, the purchase confirmation including a confirmation of the purchase of the draw lottery ticket.

18. The draw lottery ticket selling system of claim 17, wherein:
the draw lottery ticket server comprises a North American Association of State and Provincial Lotteries application programming interface (NASPL API) that is configured to:
receive the request for the draw lottery ticket from the player electronic device,
send the request for the purchase of the draw lottery ticket to the central lottery server, and
receive the response that confirms the purchase of the draw lottery ticket from the central lottery server; and
the draw lottery ticket server comprises a ticket printing interface that is configured to:
assign a lottery ticket printer from a pool of assignable lottery ticket printers, the pool of assignable lottery ticket printers comprising lottery ticket printers located at different retail locations,
generate a lottery ticket image for the draw lottery ticket, and
send the lottery ticket image to the assigned lottery ticket printer to cause the assigned lottery ticket printer to print the draw lottery ticket.

19. The draw lottery ticket selling system of claim 18, wherein the purchase confirmation comprises the lottery ticket image for the draw lottery ticket.

20. The draw lottery ticket selling system of claim 19, wherein the plurality of instructions, when executed by the processor, cause the processor to cause the assigned lottery ticket printer to print the draw lottery ticket after a winning ticket printing condition has been met.
